(19) United States
(12) Patent Application Publication
(10) Pub. No.: US 2022/0240506 A1
(43) Pub. Date: Aug. 4, 2022

(54) ORGANIC ACYL HALOSULFONAMIDE BIOCIDE COMPOSITIONS AND METHODS OF MAKING AND USING THE COMPOSITIONS

(71) Applicant: Truox, Inc.

(72) Inventor: Roy W. Martin, Naples, FL (US)

(73) Assignee: Truox, Inc., Alpine, WY (US)

(21) Appl. No.: 17/571,715

(22) Filed: Jan. 10, 2022

Related U.S. Application Data
(60) Provisional application No. 63/143,625, filed on Jan. 29, 2021.

(51) Int. Cl. A01N 41/06; A01P 1/00

(52) U.S. Cl. CPC A01N 41/06; A01P 1/00

(57) ABSTRACT

Biocide compositions comprising organic acyl halosulfonamides and methods for their use. The inherent stability provided by the molecular structure and enhanced penetration due to reductions in surface tension provides superior biocidal efficacy and overall application performance compared to traditional oxidizing biocides.

### FIELD OF THE INVENTION

The present invention relates to organic acyl halosulfonamide biocide compositions and methods for producing and using the organic acyl halosulfonamide biocide compositions. The organic acyl halosulfonamide biocide compositions have utility in applications such as food intervention, water treatment and hard surface cleaning.

### BACKGROUND OF THE INVENTION

Biocide compositions are commonly used for the treatment of recirculating systems such as industrial cooling systems and swimming pools, disinfecting hard surfaces, food intervention, disinfecting food processing equipment and the like.

Peracids have and continue to be used as biocides in the treatment of food products as well as in oil and gas, cooling towers and the like. Specifically in the case of food intervention, the reduction in microbial activity is typically less than a 2-log and more often reported to be less than 1-log. The Food and Drug Administration (FDA) restricts the use of peracids to 220 ppm as peracetic acid under 21 C.F.R. 173.370. One of the primary reasons for restricting the use of peracids is the potential bleaching and discoloration of the meats being treated. Peracids are highly reactive, far more so than hydrogen peroxide. As a result, peracids tend to oxidize on contact, thereby potentially bleaching the food products as well as other items they contact.

Peroctanoic acids are reported to improve surfactant properties but demonstrate little to no improvements over peracetic acid.

There is a great need for a stable surface tension reducing biocide that can be applied in sufficient concentrations to effectively reduce surface tension, penetrate crevices and organic films, be absorbed by microorganisms, undergo decompose within the microorganisms thereby releasing an effective biocide and inactivating the said organisms. There is also a need for a biocide that reduces or avoids bleaching and discoloration of meats being treated.

### SUMMARY OF THE INVENTION

The present invention is based on the discovery of a new oxidizer that comprises organic acyl halosulfonamide compounds. It has been discovered that these new compounds provide excellent stability and a surprisingly high level of antimicrobial efficacy. These powerful oxidizing compounds were found to be unexpectedly stable in an aqueous solution under a wide range of pH. The discovery of organic acyl halosulfonamide compounds bring to light a new generation of efficient and environmentally friendly biocide compositions.

The organic acyl halosulfonamide compounds of the invention provide numerous unexpected advantages over percarboxylic acids, chlorous acid, chlorine dioxide, hypochlorites, and other commonly used oxidizing biocides. Examples of unexpected benefits include but are not limited to: high stability in the presence of many organics increases survivability in antimicrobial applications; the organic acyl halosulfonamide compounds once produced are stable over a broad pH range; solid forms of organic acyl halosulfonamide may be produced; the organic portion of the organic acyl halosulfonamide can be selected to increase the molecules lipophilicity to increase permeation through the cell membranes of microbiological organisms, and be applied at higher concentrations to food products without concern of bleaching the food item being treated.

Definitions used herein:

As used herein, “organic acyl halosulfonamide” describes a compound having the general formula:

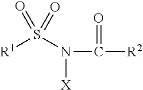

wherein X comprises a halogen;
R¹ comprises benzene, substituted benzene derivatives, heterocyclic or substituted heterocyclic derivatives, and
R² comprises a C₁ to C₁₉ carbon based structure.

As used herein, “carbon-based structure” is a carbon-based structure directly appending the acyl carbon group of the organic acyl halosulfonamide. The carbon-based structure can be selected from an alkyl or alkene group comprising the tail of a fatty acid or fatty acid derivative. The carbon-based structure can be saturated or unsaturated as well as substituted or unsubstituted. Preferred carbon-based structures are selected from saturated or unsaturated alkyl chains ranging from C₁ to C₁₉, more preferred C₃ to C₁₇, and most preferred C₅ to C₁₅. A preferred carbon-based structure is an alkyl group comprising the tail of the fatty acid or fatty acid derivative.

As used herein, “organic acyl donor” comprises organic based compounds that result in formation of organic acyl halosulfonamide compounds when reacted with a halosulfonamide. Examples of organic acyl donors include carboxylic acids, and carboxylic acid derivatives exemplified by acid chlorides (RCOC1), anhydrides (RCO2COR), esters (RCO2R), and amides (RCONH2). Preferred organic acyl donors comprise acid chlorides and anhydrides.

As used herein, “water” refers to any media that comprises at least some proportion of water having the general formula H₂O. The biocide compositions comprising organic acyl halosulfonamide and water are not limited to water in its pure form H₂O. Water also refers to water used as a means of dilution of biocide and bleach compositions. Water also refers to systems or applications comprising mostly H₂O exemplified by recirculating cooling tower systems.

As used herein, the term “aqueous solution” means the solution comprises at least some portion of water having the general formula H₂O. Aqueous solutions may further include significant proportions of other solvents exemplified by alcohols, dimethyl sulfoxide (DMSO), acetone, ethyl acetate, as well as other additives exemplified by surfactants, dispersants, sequestrants, chelants, oxidizers such as hydrogen peroxide and peracids, colorants, perfumes, viscosity modifiers and the like. An aqueous solution may also be an emulsion, a suspension, or a hydrogel.

As used herein, the singular forms “a,” “an,” and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

As used herein, “biocide composition” refers to a composition comprising at least one organic acyl halosulfonamide that kills microorganism such as bacteria. The biocide compositions inactivate microbiological organisms and are applied where antimicrobial activity is desired. Biocide compositions can be formulated with other additives and adjuvants to meet the requirements of specific applications.

As used herein, “effective amount” refers to the amount of biocide composition required to achieve the desired reduction in surviving microorganisms. The effective amount of biocide composition required to achieve the desired level as a sanitizer or disinfectant can vary depending on factors such as concentration, temperature, contact time, oxidant demand type of organic acyl halosulfonamide used and the like.

As used herein, the term “sanitizer” refers to an agent that reduces the number of bacterial contaminants to safe levels as judged by public health requirements. These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

As used herein, the term “disinfectant” refers to an agent that kills all vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15th Edition, 1990 (EPA Guideline 91-2).

As used in this invention, the term “sporicide” refers to a physical or chemical agent or process having the ability to cause greater than a 90% reduction (1-log order reduction) in the population of spores of Bacillus cereus or Bacillus subtilis within 10 seconds at 60° C. In certain embodiments, the sporicidal compositions of the invention provide greater than a 99% reduction (2-log order reduction), greater than a 99.99% reduction (4-log order reduction), or greater than a 99.999% reduction (5-log order reduction) in such population within 10 seconds at 60° C.

As used herein, “weight percent” also “wt %” refers to the concentration of a substance in a composition. The weight percent calculated by taking the weight of that substance divided by the weight of the composition and multiplying the value by 100.

As used herein, the term “recirculating system” refers to any open or closed aqueous system that comprises a reservoir of water and a system of piping to transport the water, and wherein the water transported through the piping is eventually returned to the reservoir. Examples of recirculating systems include but are not limited to: cooling systems including cooling towers and cooling ponds; swimming pools; fountains; chilled water systems, and feature pools. Recirculating systems shall also include “once through systems” wherein the water is passed once across the heat exchangers then returned to a reservoir such as a pond, lake, river, or holding tank.

As used herein, the term “food product” or “food” refers to any food or beverage item that may be consumed by humans or mammals. Some non-limiting examples of a “food product” or “food” include the following: meat products including ready-to-eat (“RTE”) meat and poultry products, processed meat and poultry products, cooked meat and poultry products, and raw meat and poultry products including beef, pork, and poultry products; fish products including cooked and raw fish, shrimp, and shellfish; produce including whole or cut fruits and vegetables and cooked or raw fruits and vegetables; pizzas; readymade breads and bread doughs; cheese, eggs, and egg-based products; and pre-made food items such as pre-made sandwiches. The present invention is particularly useful for meat and poultry products. Specific examples of meat products including RTE deli or luncheon meats like turkey, ham, roast beef, hot dogs, and sausages. Additionally, the present invention can be used on bacon and pre-made, pre-assembled, or pre-packaged meals such as TV dinners and microwaveable entrees or meals.

As used herein “food processing systems” refers to the surfaces of equipment and surroundings used to process food. Food processing systems includes the equipment and building structures used to process, produce, store, wash, move, sanitize, cut, and package consumable food items.

As used herein, “food intervention” refers to the treatment of a food product or food, and/or food processing equipment with a biocide composition comprising an organic acyl halosulfonamide to killing one or more of the food-borne pathogenic bacteria associated with a food product, such as Salmonella typhimurium, Salmonella javiana, Campylobacter jejuni, Listeria monocytogenes, Escherichia coli O157:H₇, and the like.

As used herein, “hard surfaces” include: countertops; floors; walls; tables; cabinets; doors; doorknobs; food processing equipment, and the like. Hard surfaces are found in industrial and institutional facilities including hospitals, food processing facilities, day care centers, nursing homes, cafeterias, Universities, schools, and the like.

As used herein, the phrase “health care equipment” refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, or fixtures of structures in which health care occurs. Health care surfaces are found in hospital, surgical, infirmity, birthing, mortuary, and clinical diagnosis rooms. These surfaces can be those typified as “hard surfaces” (such as walls, floors, bed-pans, etc.,) or fabric surfaces, e.g., knit, woven, and non-woven surfaces (such as surgical garments, draperies, bed linens, bandages, etc.,) or patient-care equipment (such as respirators, diagnostic equipment, shunts, body scopes, wheel chairs, beds, etc.,) or surgical and diagnostic equipment. Health care surfaces include articles and surfaces employed in animal health care.

As used herein, the phrases “medical instrument”, “dental instrument”, “medical device”, “dental device”, “medical equipment”, or “dental equipment” refer to instruments, devices, tools, appliances, apparatus, and equipment used in medicine or dentistry. Such instruments, devices, and equipment can be cold sterilized, soaked or washed and then heat sterilized, or otherwise benefit from cleaning in a composition of the present invention. These various instruments, devices and equipment include, but are not limited to: diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, scopes (e.g., endoscopes, stethoscopes, and arthoscopes) and related equipment, and the like, or combinations thereof.

As used herein, “laundry” refers to fabric-based clothing, uniforms, towels, rags, and linens that require cleaning to remove stain causing chromophores, dirt, undesirable dye, and/or sanitizing or disinfecting to remove pathogens.

As used herein, “laundry wash-water” refers to water or aqueous solution used to clean, bleach, sanitize and/or disinfect fabric-based clothing, uniforms, towels, rags, and linens.

### DETAILED DESCRIPTION OF THE INVENTION

It has been discovered that stable organic acyl halosulfonamide compositions can be produced that are surprisingly and unexpectedly effective biocide compositions. These compositions provide unprecedented features and benefits compared to other oxidizing antimicrobials exemplified by sodium hypochlorite, hydrogen peroxide, chlorine dioxide, and peroxyacids. Without being bound by a particular theory, it is believed that the improved efficacy of the biocide compositions of the invention is the result of increased absorption of the biocide by bacteria and activation (release) of the halosulfonamide within the bacteria by enzyme cleavage at the acyl carbon group.

The invention includes a method for killing microorganisms comprising the steps of: forming a biocide composition comprising a carrier and an organic acyl halosulfonamide having the general formula;

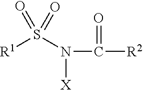

Where X comprises a halogen;
R¹ comprises benzene, substituted benzene derivatives, heterocyclic or substituted heterocyclic derivatives;
R² comprises a C₁ to C₁₉ carbon-based structure, and
   contacting the microorganisms with an effective amount of biocide composition. The halogen “X” can be selected from chlorine, bromine or iodine. The preferred halogen is chlorine.

Preferred non-limiting examples of benzene derivatives include: chlorobenzene, methylbenzene, ethylbenzene, hydroxybenzene, aminobenzene, methoxybenzene, benzamide, benzonitrile, nitrobenzene, iodobenzene, fluorobenzene, bromobenzene, benzenecarboxylic acid, benzenecarbaldehyde, methyl benzoate, 1-phenylethanone and the like.

Preferred non-limiting examples of heterocyclic and heterocyclic derivatives include: furan, 1,3-dioxolane, tetrahydrothiophene, thiophene, thiazole, pyrrolidine, 3-pyrroline, 2-pyrroline, 2H-pyrrole, pyrazolidine, imidazole, imidazolidine, pyrazole, 2-pyrazoline, pyridine, piperidine, pyridazine, thiane, aminopyridine, pyridinecarboxylic, nitropyridine, aminothiazole, quinoline, tetrahydropyran, and the like.

Non-limiting examples of organic halosulfonamides include: N-chloro 4-methylbenzenesulfonamide, N-bromo 4-methylbenzenesulfonamide, N-chloro benzenesulfonamide, N-chloro tert-butylsulfonamide, N-bromo tert-butylsulfonamide, N-chloro furansulfonamide, N-bromo furan sulfonamide, N-chloro thiopenesulfonamide, N-bromo pyrrolesulfonamide and the like.

The invention provides surprising and unexpected improvements and benefits over traditional oxidizing biocides exemplified by chlorine and chlorine donors, chlorine dioxide, peracids, and stabilized chlorine such as chloramines T. Take for example the use of traditional oxidizers used for food intervention. These oxidizers begin oxidizing the food product on contact thereby increasing the potential for discoloration and compromising the quality of the food product being treated. The majority of the oxidation occurs on or near the external surface of the microorganism cell thereby inducing cell membrane lysis. As a result, other forms of oxidant demand will also induce reduction of the oxidizer and thereby reduce the active concentration and subsequent rate of reaction with microorganisms. In contrast, in the case of organic acyl halo sulfonamides, the potential for oxidation when contacting the food product and/or other forms of oxidant demand is substantially reduced or altogether eliminated.

Without being bound by theory, it is believed the coupling of the halosulfonamide with the organic acyl group blocks the chloramine from interacting with oxidant demand via steric hindrance. The increased hydrophobicity afforded by the R² group increases the molecules ability to penetrate porous surface by reducing surface tension and allows the biocide to penetrate crevices and biofilms. Furthermore, bacteria commonly found on foods that induce food poisoning exemplified by Salmonella and E-coli utilize enzymes such as Acyl-CoA to convert externally supplies sources of fatty acids into useful membrane lipids. Coupling a fatty acid with the halosulfonamide increases the absorption into the bacteria. Once inside the bacteria, the metabolized biocide results in the release of the halosulfonamide within the bacteria where it undergoes reduction, resulting in cellular oxidation and subsequent death of the microorganism.

The unexpected and surprising benefits of the disclosed invention over traditional oxidizers are numerous.

Steric hindrance reduces the potential for oxidizing the food product thereby allowing for higher concentrations to be applied. Steric hindrance inhibits oxidant demand from reducing the concentration of the biocide, thereby allowing higher concentrations to survive the penetration of crevices and biofilms. The alkyl group comprising the tail of the fatty acid group reduces surface tension enhancing penetration and better surface coverage. The fatty acid group furthermore improves cellular absorption resulting in the internal decoupling of the halosulfonamide and subsequent cellular oxidation resulting in cell death.

Carbon based structure R².

In biocide applications where the primary carbon-based structure requires wetting, surface activity, and membrane permeation, generally C₅ to C₁₉ primary carbon-based structures are employed. Lower cost products can be produced using saturated and unsaturated fatty acids to produce the organic acyl halosulfonamide. The carbon-based structure (R²) can be selected from alkyl or alkene groups and can be substituted or unsubstituted. The preferred carbon-based structure comprises the tail of an alkyl or alkene fatty acid or fatty acid derivative, making the organic acyl halosulfonamide compound surface active. Surface activity assists in wetting hydrophobic surfaces as well as absorption into the microorganism's membrane.

### Preferred Embodiments

A first embodiment of the invention comprises a biocide having the general formula:

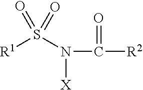

where X comprises a halogen;
R¹ comprises benzene, substituted benzene derivatives, heterocyclic or substituted heterocyclic derivatives, and
where R² comprises a C₁ to C₁₉ carbon-based structure.

In a second embodiment of the invention, there is provided a method for killing microorganisms comprising the steps of:
forming a biocide composition comprising a carrier and an organic acyl halosulfonamide having the general formula;

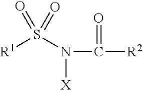

where X comprises a halogen;
R¹ comprises benzene, substituted benzene derivatives, heterocyclic or substituted heterocyclic derivatives; and
R² comprises a C₁ to C₁₉ carbon-based structure, and contacting the microorganisms with an effective amount of the biocide composition.

In a third embodiment of the invention, there is provided a method for internal cellular oxidation by:
absorption of organic acyl halosulfonamide; enzyme cleavage of the halosulfonamide from the organic acyl group; and
halosulfonamide reduction resulting in cellular oxidation, wherein cellular oxidation kills the microorganism.

In another embodiment of the invention, there is provided a method for food intervention for the control of food-borne pathogenic bacteria comprising contacting the food with the biocide composition.

In another embodiment of the invention, there is provided a method for sanitizing or disinfecting hard surfaces comprising contacting the hard surfaces with the biocide composition.

In another embodiment of the invention, there is provided a method for sanitizing or disinfecting recirculating systems.

Reactants for Producing Organic Haloamines.

Organic acyl donors can include carboxylic acid and carboxylic acid derivatives exemplified by acyl chlorides (RCOC1), acid anhydrides (RCO2COR), esters (RCO2R), and amides (RCONH2). Preferred organic acyl donors are acid chlorides and anhydrides.

Fatty Acids.

Fatty acids are inexpensive sources of organic acyl donors that can be selected to provide increased hydrophobicity to enhance permeation of cell membranes as well as reduce surface tension to penetrate biofilms and improve surface distribution. Non-limiting examples of saturated alkyl fatty acids include but are not limited to: caprylic acid, capric acid, lauric acid, myristic acid, palmitic acid, stearic acid, arachidic acid, behenic acid, lignoceric acid. Non-limiting examples of unsaturated alkyl carboxylic fatty acid include but are not limited to: myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid. Fatty acid chlorides and anhydrides react with the halosulfonamide anion to produce an organic acyl halosulfonamide biocide.

Methods of Preparing Organic Acyl Halosulfonamide.

Reactants capable of producing the organic acyl halosulfonamide compounds include carboxylic acids and derivatives of carboxylic acids. The conditions necessary to produce the desired organic acyl halosulfonamide can vary significantly dependent on the source of organic acyl donor. For example, acyl chlorides are very susceptible to nucleophilic acyl substitution. Acid anhydrides are also very useful and are readily available. These readily reactive carboxylic acid derivatives allow for broader range of reaction conditions while resulting in efficient conversion of reactants to the desired organic acyl halosulfonamide compounds.

Carboxylic acids, as well as the carboxylic acid esters and amides may also be used to produce the organic acyl polyoxychlorine compositions of the invention but in general require their own set of conditions and/or longer reaction times when compared to acid anhydrides and acid chlorides. TAED (Tetra Acetyl Ethylene Diamine) is an amide containing carboxylic acid derivative that may be used under alkaline conditions to produce organic acyl halosulfonamide compounds.

Methods of Preparing Biocide Compositions.

After the organic acyl halosulfonamide compounds are produced, they can be used as is, diluted, the pH can be adjusted, or they may be formulated with other additives and adjuvants to produce the desired biocide composition. The biocide compositions may have a range of physical forms. For example, the biocide compositions may be a solid, liquid, suspension, emulsion, gel. Dried solid forms may be formed into a pellet, prill, tablet or a powder.

Carriers can be combined with the organic acyl halosulfonamide to produce a biocide composition. Carriers can comprise any suitable liquid such as water or a pharmaceutically acceptable solvent. Non-limiting examples of carriers include water, dimethylsulfoxide, ethanol, propylene glycol, mineral oil, and glycerin.

The biocide composition can comprise from 0.01 to 99.99 wt % organic acyl halosulfonamide and 0.09 to 99.99 wt % carrier, preferably 0.1 to 90 wt % organic acyl halosulfonamide and 10 to 99.9 wt % carrier, and most preferred 0.1 to 50 wt % organic acyl halosulfonamide and 50 to 99.9 wt % carrier.

The biocide composition can be applied in a sufficient amount to achieve a desired concentration of organic acyl halosulfonamide. For example, application of a biocide composition for use in food intervention such as application to a meat carcass may provide from 1 to 10,000 ppm, preferably 10 to 5,000 ppm, and more preferred 50 to 1,000 ppm organic acyl halo sulfonamide.

The compositions of the invention can also include a carrier. The carrier provides a medium which dissolves, suspends, or carries the biocide composition as well as optional additives of the composition. For example, the carrier can provide a medium for solubilization, suspension, or production of organic acyl halosulfonamide. The carrier can also function to deliver and wet the antimicrobial composition of the invention on an object. To this end, the carrier can contain any component or components that can facilitate these functions. Generally, the carrier includes primarily water which can promote solubility and work as a medium for reaction. The carrier can include or be primarily an organic solvent, such as simple alkyl alcohols, e.g., ethanol, isopropanol, n-propanol, dimethyl sulfoxide (DMSO), acetone and the like. Polyols are also useful carriers, including glycerol, sorbitol, and the like. Suitable carriers include glycol ethers. Suitable glycol ethers include diethylene glycol n-butyl ether, diethylene glycol n-propyl ether, diethylene glycol ethyl ether, diethylene glycol methyl ether, diethylene glycol t-butyl ether, dipropylene glycol n-butyl ether, dipropylene glycol methyl ether, dipropylene glycol ethyl ether, dipropylene glycol propyl ether, dipropylene glycol tert-butyl ether, ethylene glycol butyl ether, ethylene glycol propyl ether, ethylene glycol ethyl ether, ethylene glycol methyl ether, ethylene glycol methyl ether acetate, propylene glycol n-butyl ether, propylene glycol ethyl ether, propylene glycol methyl ether, propylene glycol n-propyl ether, tripropylene glycol methyl ether and tripropylene glycol n-butyl ether, ethylene glycol phenyl ether (commercially available as DOWANOL EPH™ from Dow Chemical Co.), propylene glycol phenyl ether (commercially available as DOWANOL PPH™ from Dow Chemical Co.), and the like, or mixtures thereof.

Coupling Agents.

The biocide composition may include one or more coupling agents for maintaining the raw materials of the composition in solution. The coupling agent is preferably a Generally Recognized as Safe (GRAS) by the FDA or food additive raw material. Some non-limiting examples of suitable coupling agents include propylene glycol esters, glycerol esters, polyoxyethylene glycerol esters, polyglycerol esters, sorbitan esters, polyoxyethylene sorbitan esters, polyoxyethylene-polyoxypropylene polymers, sulfonates, dioctyl sodium succinate, stearoyl lactylate, and complex esters such as acetylated, lactylated, citrated, succinhylated, or diacetyl tartarated glycerides. The coupling agent is preferably a sorbitan ester such as polyoxyethylene (20) sorbitan monooleate, commercially available as Polysorbate 80, polyoxyethylene (20) sorbitan monostearate, commercially available as Polysorbate 60, and polyoxyethylene (20) sorbitan monolaurate, commercially available as Polysorbate 20.

Surfactants can be incorporated into the biocide and bleach compositions to reduce the surface tension, improve wetting, improve detergency, and provide foaming capability. Specific non-limiting examples include Poly(ethylene glycol)-block-poly(propylene glycol)-block-poly(ethylene glycol) copolymer surfactants sold under the trade name Pluronic® manufactured by BASF (e.g. Pluronic 31R1, Pluronic P103), alkyldiphenyloxide disulfonate exemplified by Dowfax C10L and Dowfax C6L sold by Dow Chemical, Tergitol TMN6, Tergitol TMN3, Triton DF12, also sold by Dow Chemical, ethoxylated alcohols sold under the trade name Tomadol® and alkoxylated surfactants sold under the tradename Nonidet™ both sold by Air Products, alkylglycosides exemplified by Triton BG-10, Triton CG-50, Triton CG-110 sold by Dow Chemical, block copolymers exemplified by Pluronic P103, Pluronic 31R1 sold by BASF. Surfactants are useful as detergents as well as increasing wetting and penetration of membranes and deposits.

Dispersants such as tripolyphosphate, hexametaphosphate, polyacrylic acid can be useful in dispersing soils so the biocide composition can penetrate deposits to effectively contact and kill the microorganisms.

Sequestrants are useful in both biocide compositions and bleach compositions of the invention to penetrate deposits and soils, dissolve and stabilize various metals. Specific non-limiting examples of phosphonate compounds that may be suitable in biocide compositions include but may not be limited to: 2-Aminoethylphosphonic acid, Dimethyl methylphosphonate, 1-Hydroxy Ethylidene-1,1-Diphosphonic Acid, Amino tris(methylene phosphonic acid), Ethylenediamine tetra(methylene phosphonic acid), Tetramethylenediamine tetra(methylene phosphonic acid), Hexamethylenediamine tetra(methylene phosphonic acid), Diethylenetriamine penta(methylene phosphonic acid), Phosphonobutane-tricarboxylic acid, N-(phosphonomethyl)iminodiacetic acid, 2-carboxyethyl phosphonic acid, 2-Hydroxyphosphonocarboxylic acid, Amino-tris-(methylene-phosphonic acid). Chelants are useful in biocide compositions compositions of the invention to penetrate mineral deposits, dissolve and stabilize various metals. Specific non-limiting examples of chleants that may be suitable in biocide and bleach compositions include but may not be limited to: ethylenediamine tetraacetic acid, diethylene triamine pentaacetic acid, N-(hydroxyl ethyl) ethylenetriaminetriacetic acid, nitrilotriacetic acid.

Corrosion inhibitors are useful for inhibiting the corrosion of metals, glass and materials that may be subjected to high concentrations of the biocide compositions of the invention. Specific non-limiting examples include: phosphate esters, sodium nitrate, sodium molybdate, sorbic acid, polyphosphates, sodium silicates, sodium borate, tolytriazole, carboxybenzotriazole, sodium tolytriazole.

Alcohols are often incorporated into formulations as solvents to enhance penetration of deposits and soils as well as improve solubility of some additives such as surfactants. Specific non-limiting examples of alcohols include: aliphatic alcohol exemplified by isopropyl alcohol, methanol, ethanol; aromatic alcohol exemplified by benzyl alcohol can be useful in biocide compositions; and polyhydroxy alcohols exemplified by glycerol, ethylene glycol, and propylene glycol which can also function as humectants.

Viscosity modifiers and Gel forming agents exemplified by natural, semisynthetic and synthetic polymers may be used to increase the viscosity of the formulations comprising the organic acyl halosulfonamide compounds. The polymer can be natural, such as a gum (e.g. Xanthun gum, alginates, carrageenan), semisynthetic such as a polysaccharides (i.e. microcrystalline cellulose, methylcellulose, hydroxyethylmethylcellulose, hydroxypropylmethylcellulose), or synthetic such as a poloxamers and carbomers.

Indicators may be added to biocide compositions to indicate the activity of the oxidizing biocide. Methylene blue and amaranth are two examples of indicators that may be suitable for use in these compositions.

Other ingredients that may be used in stabilized biocide compositions of the invention include fragrances, dyes, and flavors to provide a desirable esthetic value.

Application of the Biocide Compositions

Food Intervention.

The biocide composition may be applied to the food product prior to, or substantially simultaneously with the packaging of the food product. Alternatively, the composition may be applied to the food product without packaging.

The biocide composition includes an amount of organic acyl halosulfonamide effective for killing one or more of the food-borne pathogenic bacteria associated with a food product, such as Salmonella typhimurium, Salmonella javiana, Campylobacter jejuni, Listeria monocytogenes, and Escherichia coli O157:H₇ and the like.

The biocide composition may be applied to the food product in any desired manner. In some embodiments, the biocide composition may be applied directly to the food product in a number of ways including spraying, misting, rolling, and foaming the biocide composition directly onto the food product and the like, and immersing the food product in the biocide composition.

The biocide composition can be applied to the packaging prior to inserting the food product into the packaging or prior to applying the packaging to the food product. The biocide composition then contacts the food product when the food product is packaged. As used herein, a “packaged food product” means a food product that has been placed in packaging but not yet sealed. The biocide composition can be applied to the packaging after the food product has been inserted into the packaging or after applying the packaging to the food product (e.g., the biocide composition may be squirted or otherwise introduced into the packaging after the food has been placed in the packaging but prior to sealing the packaging).

The biocide composition may be applied to the food product substantially simultaneously with the packaging of the food product. Additionally, food packaging or food casing (e.g., hot dog or sausage casing) may be coated, treated, or impregnated with the biocide composition, and the biocide composition is applied to the food product when the food product is placed inside the packaging or casing.

The biocide compositions can also be used on foods and plant species to reduce surface microbial populations; used at manufacturing or processing sites handling such foods and plant species; or used to treat process waters around such sites. For example, the biocide compositions can be used on food transport lines (e.g., as belt sprays); boot and hand-wash dip-pans; food storage facilities; anti-spoilage air circulation systems; refrigeration and cooler equipment; beverage chillers and warmers, blanchers, cutting boards, third sink areas, and meat chillers or scalding devices. The biocide compositions of the invention can be used to treat produce transport waters such as those found in flumes, pipe transports, cutters, slicers, blanchers, retort systems, washers, and the like. Particular foodstuffs that can be treated with compositions of the invention include eggs, meats, seeds, leaves, fruits and vegetables. Particular plant surfaces include both harvested and growing leaves, roots, seeds, skins or shells, stems, stalks, tubers, corms, fruit, and the like. The biocide compositions may also be used to treat animal carcasses to reduce both pathogenic and non-pathogenic microbial levels. The biocide composition is useful in the cleaning or sanitizing of containers, processing facilities, or equipment in the food service or food processing industries. The biocide compositions have particular value for use on food packaging materials and equipment, and especially for cold or hot aseptic packaging. Examples of process facilities in which the biocide composition of the invention can be employed include a milk line dairy, a continuous brewing system, food processing lines such as pumpable food systems and beverage lines, etc. Food service wares can be disinfected with the biocide composition of the invention. For example, the biocide compositions can also be used on or in ware wash machines, dishware, bottle washers, bottle chillers, warmers, third sink washers, cutting areas (e.g., water knives, slicers, cutters and saws) and egg washers. Particular treatable surfaces include packaging such as cartons, bottles, films and resins; dish ware such as glasses, plates, utensils, pots and pans; ware wash machines; exposed food preparation area surfaces such as sinks, counters, tables, floors and walls; processing equipment such as tanks, vats, lines, pumps and hoses (e.g.; dairy processing equipment for processing milk, cheese, ice cream and other dairy products); and transportation vehicles. Containers include glass bottles, PVC or polyolefin film sacks, cans, polyester, PEN or PET bottles of various volumes (100 ml to 2 liter, etc.), one gallon milk containers, paper board juice or milk containers, etc.

The biocide composition may also be employed by dipping food processing equipment into the use solution, soaking the equipment for a time sufficient to sanitize the equipment, and wiping or draining excess solution off the equipment, The biocide composition may be further employed by spraying or wiping food processing surfaces with the use solution, keeping the surfaces wet for a time sufficient to sanitize the surfaces, and removing excess solution by wiping, draining vertically, vacuuming, etc. The biocide composition may also be employed by dipping food processing equipment into the use solution, soaking the equipment for a time sufficient to sanitize the equipment, and wiping or draining excess solution off the equipment, The biocide composition may be further employed by spraying or wiping food processing surfaces with the use solution, keeping the surfaces wet for a time sufficient to sanitize the surfaces, and removing excess solution by wiping, draining vertically, vacuuming, etc.

Food processing surfaces, food products, food processing or transport waters, and the like can be treated with liquid, foam, gel, aerosol, gas, wax, solid, or powdered biocide compositions according to the invention, or solutions containing these compositions.

The present method and system provide for contacting a food product with a biocide composition employing any method or apparatus suitable for applying such a biocide composition. For example, the method and system of the invention can contact the food product with a spray of the biocide composition, by immersion in the biocide composition, by foam or gel treating with the biocide composition, or the like. Contact with a spray, a foam, a gel, or by immersion can be accomplished by a variety of methods known to those of skill in the art for applying antimicrobial agents to food. Contacting the food product can occur in any location in which the food product might be found, such as field, processing site or plant, vehicle, warehouse, store, restaurant, or home. These same methods can also be adapted to apply the stabilized compositions of the invention to other objects.

The present methods require a certain minimal contact time of the composition with food product for occurrence of significant antimicrobial effect. The contact time can vary with concentration of the use composition, method of applying the use composition, temperature of the use composition, amount of soil on the food product, number of microorganisms on the food product, type of antimicrobial agent, or the like. The exposure time is preferably a time sufficient to provide a desired reduced level of microbes, sanitation, disinfection. For example, the exposure time can be as low as 5 to 60 seconds or as high as 30 minutes.

In an embodiment, the method for washing food product employs a pressure spray including the biocide composition. During application of the spray solution on the food product, the surface of the food product can be moved with mechanical action, e.g., agitated, rubbed, brushed, etc. Agitation can be by physical scrubbing of the food product, through the action of the spray solution under pressure, through sonication, or by other methods. Agitation increases the efficacy of the spray solution in killing micro-organisms, perhaps due to better exposure of the solution into the crevasses or small colonies containing the micro-organisms. The spray solution, before application, for example, can also be heated to a temperature of 15 to 20° C., preferably 20 to 60° C. to increase efficacy. The spray stabilized composition can be left on the food product for a sufficient amount of time to suitably reduce the population of microorganisms, and then rinsed, drained, or evaporated off the food product.

Application of the material by spray can be accomplished using a manual spray wand application, an automatic spray of food product moving along a production line using multiple spray heads to ensure complete contact, or other spray apparatus. One automatic spray application involves the use of a spray booth. The spray booth substantially confines the sprayed composition to within the booth. The production line moves the food product through the entryway into the spray booth in which the food product is sprayed on all its exterior surfaces with sprays within the booth. After a complete coverage of the material and drainage of the material from the food product within the booth, the food product can then exit the booth. The spray booth can include steam jets that can be used to apply the stabilized compositions of the invention. These steam jets can be used in combination with cooling water to ensure that the treatment reaching the food product surface is at a desired emperature, such as less than 65° C., e.g., less than 60° C. The temperature of the spray on the food product is important to ensure that the food product is not substantially altered (cooked) by the temperature of the spray. The spray pattern can be virtually any useful spray pattern.

Immersing a food product in a liquid stabilized biocide composition can be accomplished by any of a variety of methods known to those of skill in the art. For example, the food product can be placed into a tank or bath containing the stabilized composition. Alternatively, the food product can be transported or processed in a flume of the stabilized composition. The washing solution can be agitated to increase the efficacy of the solution and the speed at which the solution reduces micro-organisms accompanying the food product. Agitation can be obtained by conventional methods, including ultrasonic, aeration by bubbling air through the solution, by mechanical methods, such as strainers, paddles, brushes, pump driven liquid jets, or by combinations of these methods. The washing solution can be heated to increase the efficacy of the solution in killing microorganisms. After the food product has been immersed for a time sufficient for the desired antimicrobial effect, the food product can be removed from the bath or flume and the stabilized composition can be rinsed, drained, or evaporated off the food product.

In another alternative embodiment of the present invention, the food product can be treated with a foaming version of the composition. The foam can be prepared by mixing foaming surfactants with the washing solution at time of use. The foaming surfactants can be nonionic, anionic or cationic in nature. Examples of useful surfactant types include, but are not limited to the following: alcohol ethoxylates, alcohol ethoxylate carboxylate, amine oxides, alkyl sulfates, alkyl ether sulfate, sulfonates, quaternary ammonium compounds, alkyl sarcosines, betaines and alkyl amides. The foaming surfactant is typically mixed at time of use with the washing solution. Examples of use solution levels of the foaming agents is from 50 ppm to 2.0 wt %. At time of use, compressed air can be injected into the mixture, then applied to the food product surface through a foam application device such as a tank foamer or an aspirated wall mounted foamer.

In another alternative embodiment of the present invention, the food product can be treated with a thickened or gelled version of the composition. In the thickened or gelled version the washing solution remains in contact with the food product surface for longer periods of time, thus increasing the antimicrobial efficacy. The thickened or gelled solution will also adhere to vertical surfaces. The composition or the washing solution can be thickened or gelled using existing technologies such as: xanthan gum, polymeric thickeners, cellulose thickeners, or the like.

The biocide compositions can be used in the manufacture of beverage, food, and pharmaceutical materials including fruit juice, dairy products, malt beverages, soybean-based products, yogurts, baby foods, bottled water products, teas, cough medicines, drugs, and soft drinks. The materials can be used to sanitize, disinfect, act as a sporicide for, or sterilize bottles, pumps, lines, tanks and mixing equipment used in the manufacture of such beverages. Further, the biocide compositions can be used in aseptic, cold filling operations in which the interior of the food, beverage, or pharmaceutical container is sanitized or sterilized prior to filling. In such operations, a container can be contacted with the sanitizing biocide composition, typically using a spray, dipping, or filling device to intimately contact the inside of the container for sufficient period of time to reduce microorganism populations within the container. The container can then be emptied of the amount of sanitizer or sterilant used. After emptying, the container can be rinsed with potable water or sterilized water and again emptied. After rinsing, the container can be filled with the beverage, food, or pharmaceutical. The container can then be sealed, capped or closed and then packed for shipment for ultimate sale. The sealed container can be autoclaved or retorted for added microorganism kill.

Agriculture and Veterinary.

Biocide compositions of the invention can be applied to agricultural or veterinary objects or surfaces include animal feeds, animal watering stations and enclosures, animal quarters, animal veterinarian clinics (e.g. surgical or treatment areas), animal surgical areas, and the like.

Wound Care.

Due to the high stability of organic acyl halosulfonamide and relative selectivity due to intracellular activation, the biocide composition may be an excellent candidate for use in wound care. Wound wash solutions, crémes, paste, gels, may be suitable for inclusion of the biocide composition. The biocide compositions of the invention may also be embedded into wound dressings applied to a wound.

Hard and/or Soft Surfaces.

Biocide compositions of the present invention can be used as a concentrate or as a diluted solution. A biocide composition can be applied to or brought into contact with an object by any conventional method or apparatus for applying an antimicrobial or cleaning composition to an object. For example, the object can be wiped with, sprayed with, foamed on, and/or immersed in the composition, or a diluted use solution made from the composition. The composition can be sprayed, foamed, or wiped onto a surface; the composition can be caused to flow over the surface, or the surface can be dipped into the composition. Contacting can be manual or by machine.

The compositions of the invention can be used for a variety of domestic or industrial applications, e.g., to reduce microbial or viral populations on a surface or object or in a body or stream of water. The compositions can be applied in a variety of areas including kitchens, bathrooms, factories, hospitals, dental offices and food plants, and can be applied to a variety of hard or soft surfaces having smooth, irregular or porous topography. Suitable hard surfaces include, for example, architectural surfaces (e.g., floors, walls, windows, sinks, tables, counters and signs); eating utensils; hard surface medical or surgical instruments and devices; and hard-surface packaging. Such hard surfaces can be made from a variety of materials including, for example, ceramic, metal, glass, wood or hard plastic.

Recirculating Systems.

Cooling systems exemplified by once-through and cooling tower based recirculating systems can be effectively treated with biocide compositions of the invention. Cooling systems are prone to formation of biofilms and experience corrosion of heat exchangers due to microbial activity. Furthermore, loss of heat transfer and efficiency occurs when films biofilms form. Biofilm forming bacteria exemplified by Legionella Pneumophile can be effectively killed using biocide compositions due to their ability to reduce surface tension, penetrate the biofilm and persist in an environment that typically has high oxidant demand.

The biocide compositions of the invention provide significant benefits over other oxidizing biocides exemplified by hypochlorite bleach, bromine, and chlorine dioxide. First, organic acyl halosulfonamide compounds, due to their high stability are readily compatible with corrosion inhibitors and deposit control agents used to treat industrial and HVAC cooling systems. Furthermore, their stability at elevated pH and in the presence of organic contaminants provides improved efficiency in alkaline pH cooling water treatment programs used in refineries, paper mills, food processing, chemical processing industries and the like. To best meet the application needs of alkaline pH cooling water treatment programs C₃ to C₁₅ saturated and unsaturated alkyl primary carbon-based structures are preferred.

The biocide compositions of the invention can be applied as a shock feed, intermittent feed, and/or continuous feed. Generally, shock feed and intermittent feed can be achieved using chemical metering pumps, educators, manual feed, and the like. Continuous feed is typically accomplished using a chemical metering pump.

The biocide compositions can be applied to the cooling tower basin, cooling tower cold well, or any convenient location is the circulating system exemplified by injection prior to critical heat exchangers.

The biocide compositions can be stored in pails, drums, totes, or bulk tanks. Diluted solutions can be made in day-tanks wherein the biocide composition is diluted with water in a temporary storage tank and metered into the cooling system. Biocide composition can also be made at the point of use.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, steps and/or embodiments, the invention is not intended to be limited to the particulars disclosed herein. Rather, the invention extends to all functionally equivalent structures, processes and uses, such as are within the scope of the appended claims. Those skilled in the art, having the benefit of the teachings of this specification, may affect numerous modifications thereto and changes may be made without departing from the scope and spirit of the invention. While the invention has been described to provide an access hole over a buried utility, the invention can be utilized wherever an access hole in the roadway is required.

What is claimed is:

1. A method of killing microorganisms comprising the steps of:
contacting the microorganisms with an effective amount of a biocide composition to reduce a population of the microorganisms to a desired level, the biocide composition comprising a carrier and an organic acyl halosulfonamide having the general formula; 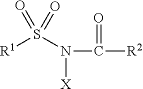
where X comprises a halogen;
R¹ comprises benzene, substituted benzene derivatives, heterocyclic or substituted heterocyclic derivatives; and
R² comprises a C₁ to C₁₉ carbon-based structure.

2. The method according to claim 1, wherein contacting the microorganism with an effective amount of biocide composition induces absorption of organic acyl halosulfonamide into the microorganism, enzyme cleavage of the halosulfonamide from the organic acyl group, halosulfonamide reduction resulting in cellular oxidation, and wherein cellular oxidation kills the microorganism.

3. The method according to claim 1, further comprising controlling food-borne pathogenic bacteria by contacting the said bacteria with the biocide composition.

4. The method according to claim 1, further comprising applying the biocide composition to a hard surface.

5. The method according to claim 1, further comprising applying the biocide composition to a recirculating system.

6. The method according to claim 1, wherein the carbon-based structure R² comprises an alkyl group.

7. The method according to claim 1, wherein the carbon-based structure R² comprises an arylalkyl group.

8. The method according to claim 1, wherein the carbon-based structure R² comprises a cycloalkyl group.

9. The method according to claim 1, wherein the carbon-based structure R² comprises an aromatic group.

10. The method according to claim 1, wherein the carbon-based structure R² comprises a heterocyclic group.

11. The method according to claim 1, wherein the carbon-based structure R² comprises a C₃ to C₁₅ alkyl group.

12. The method according to claim 1, wherein the carbon-based structure R² comprises at least one C₅ to C₁₃ alkyl group.

13. The method according to claim 1, wherein the halogen comprises chlorine.

14. The method according to claim 1, wherein the halogen comprises bromine.

15. The method according to claim 1, wherein the halogen comprises iodine.

16. The method according to claim 1, further comprising applying the biocide composition to a wound.

17. The method according to claim 1, wherein the biocide composition comprises at least one of a coupling agent, a surfactant, a dispersant, a sequestrant, a chelant, a corrosion inhibitor, an alcohol, a viscosity modifier, an activity indicator, a fragrance, a dye, or a flavor.

18. A biocide composition for killing microorganisms, the composition comprising:
a carrier; and
an organic acyl halosulfonamide having the general formula; 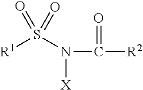
where X comprises a halogen;
R¹ comprises benzene, substituted benzene derivatives, heterocyclic or substituted heterocyclic derivatives, and
R² comprises a C₁ to C₁₉ carbon-based structure.

19. The composition according to claim 18, wherein the carbon-based structure comprises a saturated or unsaturated alkyl chain ranging from C₃ to C₁₇.

20. The composition according to claim 19, wherein the alkyl chain ranges from C₅ to C₁₅.

21. The composition according to claim 18, wherein the composition is in solid form.

22. The composition according to claim 18, wherein the composition is in liquid form.

23. The composition according to claim 18, wherein the carbon-based structure R² comprises an alkyl group.

24. The composition according to claim 18, wherein the carbon-based structure R² comprises an arylalkyl group.

25. The composition according to claim 18, wherein the carbon-based structure R² comprises a cycloalkyl group.

26. The composition according to claim 18, wherein the carbon-based structure R² comprises an aromatic group.

27. The composition according to claim 18, wherein the carbon-based structure R² comprises a heterocyclic group.

28. The composition according to claim 18, wherein the carbon-based structure R² comprises a C₃ to C₁₅ alkyl group.

29. The composition according to claim 18, wherein the carbon-based structure R² comprises at least one C₅ to C₁₃ alkyl group.

30. The composition according to claim 18, wherein the halogen comprises chlorine.

31. The composition according to claim 18, wherein the halogen comprises bromine.

32. The composition according to claim 18, wherein the halogen comprises iodine.

33. The composition according to claim 18, further comprising at least one of a coupling agent, a surfactant, a dispersant, a sequestrant, a chelant, a corrosion inhibitor, an alcohol, a viscosity modifier, an activity indicator, a fragrance, a dye, or a flavor.
